(19) United States
(12) Patent Application Publication
(10) Pub. No.: US 2011/0255724 A1
(43) Pub. Date: Oct. 20, 2011

(54) Implantable Hearing Aid With a Monitoring Transducer That Can Be Implanted In The Inner Ear

(76) Inventors: Günter Hortmann, Munchen (DE); Sebastian Hoth, Heidelberg (DE)

(21) Appl. No.: 13/091,834

(22) Filed: Apr. 21, 2011

Related U.S. Application Data
(63) Continuation of application No. PCT/EP2009/064004, filed on Oct. 23, 2009.

(30) Foreign Application Priority Data
Oct. 24, 2008 (DE) 10 2008 053 070.0

(51) Int. Cl. H04R 25/00

(52) U.S. Cl. 381/328

(57) ABSTRACT

A device for improving hearing ability comprises an input transducer which picks up the movement of the malleus in the middle ear. The input signal generated by the input transducer is supplied to a processing unit which converts the input signal into an output signal which is applied to an output transducer in the area of the round window. The conversion of the input signal into the output signal is controlled dependent upon a monitor signal generated by a monitor transducer. If the device is used, the patient retains residual hearing.

### CROSS-REFERENCE TO RELATED APPLICATIONS

This is a continuation application which is based on and claims priority to International Application PCT/EP2009/064004, which was filed on Oct. 23, 2009 and designated the United States, which is a PCT application claiming priority to German Patent Application No. 10 2008 053070.0, filed on Oct. 24, 2008, the entire disclosure of each of which is hereby expressly incorporated by reference.

### FIELD OF THE TECHNOLOGY

The disclosure relates to a hearing aid for improving hearing ability, comprising:
an input transducer by means of which a mechanical vibration associated with a sound signal to be perceived can be converted into an electrical signal,
an output transducer by means of which an electrical output signal can be converted into a sound signal propagating in the inner ear, and with
a processing circuit which is connected between the input transducer and the output transducer and which converts the input signal into the output signal.

### BACKGROUND

A hearing aid is known from DE 42 21 866 C2. In the known hearing aid, the input transducer is a flexural resonator disposed between the long limbs of the malleus and the incus. The long limb of the incus is in this case immobilized so that the movement transmitted from the tympanum onto the malleus can be acquired by the input transducer and converted into an electrical input signal. The input signal is supplied to an electronic processing unit and there converted into an output signal. The output signal is applied to an output transducer which is a liquid sound transmitter inserted into the stapes base and which at this location generates a sound signal which propagates in the inner ear.

One drawback of the known device is that the patient is largely deprived of residual hearing because the ossicular chain is interrupted due to the fixation of the incus.

### SUMMARY

According to a first aspect, there is provided a device, in which the processing unit is additionally connected to a monitor transducer by means of which a sound signal propagating in the inner ear can be converted into a monitor signal. Moreover, the conversion of the input signal into the output signal in the processing unit takes place dependent upon the monitor signal generated by the monitor transducer. With the device resonances arising due to positive amplifying feedback can be effectively suppressed since the sound signal propagating in the inner ear can be monitored by means of the monitor transducer. The frequency-selective amplification of the processing unit can in this case be set in such a way that no resonances arise due to positive amplifying feedback. This can be achieved by a negative amplification or attenuation in the frequency range of the resonance or by generation of an output signal in antiphase in the frequency range of the resonance which is rotated by 180 degrees relative to the phase of the sound signal propagating in the inner ear. Thus, it is not necessary to interrupt the ossicular chain in order to suppress a positive feedback. Accordingly, the patient can be left with residual hearing.

According to a second aspect, the input transducer is located in the area of the middle ear. In this case, this can be, in particular, an input transducer that is fixed in the mastoid cavity of the middle ear and acquires the movement of the incus body. In this arrangement, the sound transmission via the ossicular chain is retained.

According to a third aspect, the output transducer is disposed in the area of the round window of the cochlea. In that case, the distance between the output transducer and the monitor transducer can be chosen to be sufficiently large so that there is no immediate interaction between the output transducer and the monitor transducer via the mastoid, but so that output transducer and the monitor transducer interact only via the perilymph.

According to a fourth aspect, the monitor transducer is implantable into the inner ear in the area of the stapes plate. It is thus possible to effect a phase alignment between the sound signal transmitted naturally by way of the ossicular chain and the sound signal generated by the output transducer.

According to a fifth aspect, the processing unit is adapted for aligning the phase of the output signal at the location of the monitor transducer to the phase of the natural sound signal transmitted via the ossicular chain from the tympanum to the location of the monitor transducer. Thus, the two signals are superimposed at the location of the monitor transducer without any phase difference.

According to a sixth aspect, the amplification of the input signal carried out during the conversion of the input signal into the output signal can be adjusted frequency-selectively dependent upon the output amplitude of the sound signal propagating in the inner ear, in order to suppress resonances arising from positive feedback. The adjustment can take place continuously adaptively or be configured once.

According to a seventh aspect, the processing unit is a digital signal processing unit which spectrally splits the input signal and processes it in a plurality of frequency channels. In this way, the phase or amplification frequency can be frequency-selectively adapted.

According to a eighth aspect, the input transducer, the output transducer and the monitor transducer are preferably transducers produced on the basis of piezoelectric elements. Such transducers are available in a miniaturized form and have the required ruggedness.

### BRIEF DESCRIPTION OF THE DRAWINGS

Further advantages and properties are apparent from the description below in which the exemplary embodiments are explained in detail with reference to the drawing. In the figures:

FIG. 1 shows a schematic section through the interior of a human ear provided with an auditory prosthesis.

FIG. 2 shows a block circuit diagram of the auditory prosthesis; and

FIG. 3 shows an audiogram for illustrating the mode of operation of the auditory prosthesis from FIGS. 1 and 2.

### DETAILED DESCRIPTION

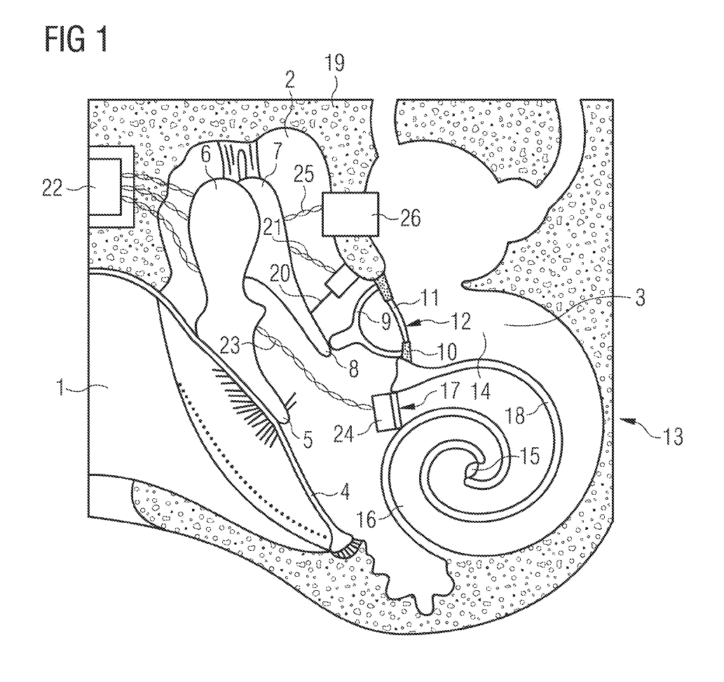

FIG. 1 shows a sectional view through an auricular channel 1, a middle ear 2 and an inner ear 3. The auricular channel 1 is sealed by a tympanum 4 against which a limb 5 of a malleus 6 rests. The malleus 6 rests against an incus 7 the limb 8 of which cooperates with a stirrup-bone 9. The stirrup-bone 9 is also referred to as stapes. A stapes base 10 together with a membrane 11 closes an oval window. The oval window 12 is adjoined by the cochlea 13. The cochlea 13 comprises a scala tympani 14 which, via a helicotrema 15, transitions into a scala vetibuli 16. The scala vestibuli 16 is sealed by a round window 17 towards the middle ear 2.

When the tympanum 4 is caused to vibrate by sound incident through the auricular channel 1, these vibrations are transmitted via the ossicular chain consisting of the malleus 6, incus 7 and stapes 9 to the oval window 12. Through the membrane 11 in the oval window 12 sound waves are excited in a perilymph present in the inner ear 3 which are converted into nerve impulses by hair cells of the cochlea 13.

It is noted that in particular the cochlea 13 is depicted in a very simplified manner. Moreover, it is noted that the scala tympani 14 and the scala vestibuli 16 interact with each other through a membrane arrangement 18 which is not depicted in detail in FIG. 1.

According to FIG. 9, in order to improve the hearing ability of the patient, an input transducer 20 is provided between the limb 8 of the incus 7 and a mastoid 19 adjacent to the middle ear 2, which can be, for example, a sound sensor and which is produced on the basis of a piezoelectric material. A mechanical movement of the incus 7 is converted by the input transducer 20 into an electrical signal that is supplied to a processing unit 22 via a line 21. In a way that is to be described in more detail later, the processing unit 22 converts the electrical input signal into an electrical output signal which is supplied to an output transducer 24 via a line 23. The output transducer 24 is preferably implanted into the inner ear 3 in the area of the round window 17. In the exemplary embodiment shown in FIG. 1 the output transducer 24 is seated in the round window 17.

Via another line 25, the processing unit 22 is connected to a monitor transducer 26 which is implanted into the inner ear 3 in the area of the round window 17.

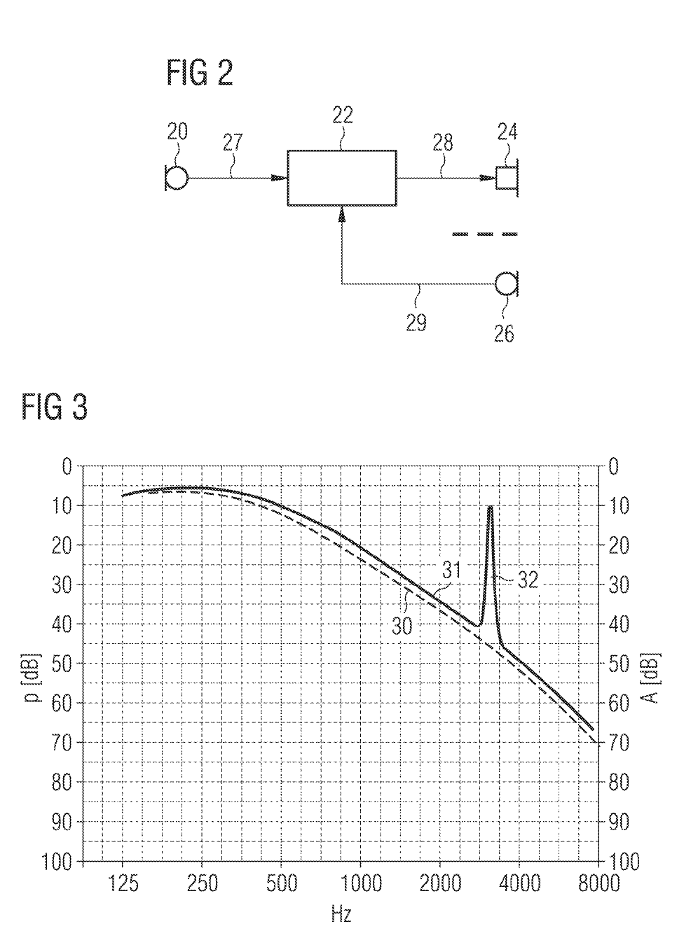

FIG. 2 shows a block circuit diagram of the device. The input transducer 20 generates an input signal 27 which is supplied to the processing unit 22. The processing unit 22 generates an output signal 28 therefrom with which the output transducer 24 is supplied. The conversion of the input signal into the output signal 28 takes place dependent upon a monitor signal 29 generated by the monitor transducer 26.

Preferably, the processing unit (22) is a digital signal processor which spectrally splits the input signal 27 into frequency channels and amplifies it in the individual frequency channels, wherein the phase in the individual frequency channels is, as a rule, respectively adjusted in such a way that the phase of the output signal 28 at the location of the monitor transducer 26 is equal to the phase of the natural sound signal transmitted via the ossicular chain from the tympanum 4 to the location of the monitor transducer 26.

Furthermore, resonances can be suppressed frequency-selectively with the processing unit 22. This shall be explained in more detail with reference to FIG. 3.

FIG. 3 shows an audiogram. The logarithmized frequency between 125 Hz and 8 kHz is shown along the abscissa. The ordinate shows the sound pressure level p in decibel (dB) required for reaching the auditory threshold. The plotted sound pressure values are respectively normalized to normal hearing so that the audiometric curve of a patient with normal hearing runs along 0 decibel. An audiometric curve 30 drawn in dashed lines in FIG. 3 represents the hearing of a patient with impaired hearing. Typically, there is little impairment of the hearing at low frequencies in the range between 125 and 500 Hz, so that the patient is able yet to perceive sound signals with a sound pressure level of less than 10 dB. However, the auditory curve 30 drops sharply towards higher frequencies. At 4 kHz, the patient is able only to perceive sound signals with a sound pressure level of more than 50 dB. The reduced hearing can be compensated by a corresponding amplification A, the behavior of which is indicated in FIG. 3 by an uninterrupted amplification curve 31. If resonance now occurs due to positive feedback between the output transducer 24 and the input transducer 20, this can be acquired by means of the monitor transducer 26. In that case, a reduction 32 of the amplification is carried out at the corresponding frequency. In the area of the reduction 32 of amplification, the input signal is amplified to a lesser degree than in the adjacent frequency ranges, or even attenuated.

It is noted that resonances can also be suppressed by shifting the phase of the output signal 28. If, for example, resonance occurs, then the phase of the output signal can be rotated by 180 degrees in the frequency range of the resonance and the occurrence of resonance can thus be avoided.

The processing unit 22 comprises a digital signal processor with a filter bank and an automatic gain control with a non-linear compression, dependent upon the output amplitude, in the full dynamic range for each of the frequency channels. Thus, the amplification is individually adjustable in each of the frequency channels in such a way that the result is the appropriate amplification. The digital signal processor is accommodated in an encapsulated implantable electronic unit. A rechargeable battery connected to the electronic unit via a hermetically sealed plug connection serves as a power supply. The rechargeable battery is recharged inductively through the skin by means of a portable device, and replaced, if necessary, with a small procedure under local anesthesia.

The device for improving hearing described herein has a number of advantages. The vibration of the tympanum 4 is not affected by the device. Implantation of the input transducer 20 and the output transducer 24 as well as of the monitor transducer 26 can be carried out by means of a posterior tympanotomy and cochleostomy. In the process, an interruption of the ossicular chain can be dispensed with so that the patient retains residual hearing.

It should be noted that, throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds or groups described in conjunction with a particular aspect, embodiment or example are to be understood to be applicable to any other aspect, embodiment or example described herein unless incompatible therewith.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. Device for improving hearing ability, comprising:
an input transducer by means of which a mechanical vibration associated with a sound signal to be perceived can be converted into an electrical signal,
an output transducer by means of which an electrical output signal can be converted into a sound signal propagating in an inner ear, and with
a processing unit, which is connected between the input transducer and the output transducer and which converts the input signal into the output signal, wherein
the processing unit is additionally connected to a monitor transducer by means of which a sound signal propagating in the inner ear can be converted into a monitor signal, and wherein
the conversion of the input signal into the output signal takes place dependent upon the monitor signal.

2. Device according to claim 1,
wherein the input transducer can be disposed in a middle ear.

3. Device according to claim 2,
wherein through the input transducer, the movement of a bone of the ossicular chain comprising the malleus, the incus and the stapes can be acquired without interruption of the ossicular chain.

4. Device according to claim 2,
wherein the monitor transducer is implantable into the inner ear.

5. Device according to claim 4,
wherein the monitor transducer is implantable into the inner ear in the area of the oval window.

6. Device according to claim 1,
wherein the output transducer can be disposed in the area of the round window.

7. Device according to claim 1,
wherein through the processing unit the phase of the output signal at the location of the monitor transducer can be adjusted to the phase of the natural sound signal transmitted via an ossicular chain from the tympanum to the location of the monitor transducer.

8. Device according to claim 1,
wherein in the processing unit, the amplification used in the conversion of the input signal into the output signal can be adjusted dependent upon an amplitude of the monitor signal.

9. Device according to claim 8,
wherein the amplification in the resonance range can be reduced frequency-selectively.

10. Device according to claim 7,
wherein the settings of the parameters used in the conversion of the input signal into the output signal can be continuously adapted to the monitor signal or can be configured, dependent upon the monitor signal, at a set-up time.

11. Device according to claim 1,
wherein the processing unit comprises a digital signal processor and that the conversion of the input signal into the output signal takes place in several frequency channels.

12. Device according to claim 1,
wherein the input transducer, the output transducer or the monitor transducer are transducers produced on the basis of a piezoelectric material.

13. Device for improving hearing ability, comprising:
an input transducer by means of which a mechanical vibration associated with a sound signal to be perceived can be converted into an electrical signal,
an output transducer by means of which an electrical output signal can be converted into a sound signal propagating in an inner ear, and with
a processing unit, which is connected between the input transducer and the output transducer and which converts the input signal into the output signal, wherein
the processing unit is additionally connected to a monitor transducer by means of which a sound signal propagating in the inner ear can be converted into a monitor signal, wherein
the conversion of the input signal into the output signal takes place dependent upon the monitor signal, and wherein
the monitor transducer is implantable into the inner ear.

14. Device according to claim 14,
wherein the output transducer can be disposed in the area of the round window.

15. Device according to claim 14,
wherein through the processing unit the phase of the output signal at the location of the monitor transducer can be adjusted to the phase of the natural sound signal transmitted via an ossicular chain from the tympanum to the location of the monitor transducer.

16. Device for improving hearing ability, comprising:
an input transducer by means of which a mechanical vibration associated with a sound signal to be perceived can be converted into an electrical signal,
an output transducer by means of which an electrical output signal can be converted into a sound signal propagating in an inner ear, and with
a processing unit, which is connected between the input transducer and the output transducer and which converts the input signal into the output signal, wherein
the processing unit is additionally connected to a monitor transducer by means of which a sound signal propagating in the inner ear can be converted into a monitor signal, wherein
the conversion of the input signal into the output signal takes place dependent upon the monitor signal, and wherein
the monitor transducer is implantable into the inner ear in the area of the oval window.

17. Device according to claim 16,
wherein the output transducer can be disposed in the area of the round window.

18. Device according to claim 16,
wherein through the processing unit the phase of the output signal at the location of the monitor transducer can be adjusted to the phase of the natural sound signal transmitted via an ossicular chain from the tympanum to the location of the monitor transducer.
